(19) United States
(12) Patent Application Publication
(10) Pub. No.: US 2011/0169607 A1
(43) Pub. Date: Jul. 14, 2011

(54) LONG RANGE PASSIVE REAL TIME LOCATION SYSTEM

(75) Inventor: Brett L. Paulson, Palo Alto, CA (US)

(73) Assignee: NARATTE INC., Palo Alto, CA (US)

(21) Appl. No.: 12/687,069

(22) Filed: Jan. 13, 2010

(51) Int. Cl. H04Q 5/22

(52) U.S. Cl. 340/10.1

(57) ABSTRACT

Methods and systems for providing a long-range real-time location system comprise transmitting a power signal from one or more exciters to at least a portion of the tags, wherein the exciters are located a distance from the tags within a range required to power the tags; initiating transmission of the power signal by a reader that transmits a command signal instructing the exciters to transmit the power signal to the tags, wherein the reader is located a greater distance from the tags than the range required to power the tags; receiving by multiple wideband antennas on the reader, wideband signals from at least one of the tags, and associating with the wideband signals a time of arrival at each of the wideband antennas; and calculating by the reader a location of the at least one tag based on differences between the time of arrival at each of the wideband antennas.

### BACKGROUND

Radio-frequency identification (RFID) is a data collection technology that uses electronic tags (called RFID tags) for storing data. RFID tags are typically applied to or incorporated into an item, such as a product, animal, or person for the purpose of identification and tracking using radio waves. The tag, also known as an electronic label, or transponder, comprises an RFID chip attached to an antenna. Tags are typically passive or active. Passive tags have no power source but use the electromagnetic waves from the reader to energize the chip and transmit back their data. Passive tags can cost less than a quarter and be read up to approximately 10 feet from the reader's antenna. Active tags have a battery or other power source that can transmit up to 300 feet indoors and more than a thousand feet outdoors. Active tags can cost up to several dollars and may periodically transmit a signal for a reader to pick up or may lie dormant until the tags sense a signal from a reader or use sensor readings on the tag to initiate a transmit signal to the reader. The reader, also called an interrogator, is a transmitter/receiver that receives transmission from the tags in the vicinity to read the tag's contents. The maximum distance between the reader's antenna and the tag vary, depending on application.

Many RFID systems exist. For example, U.S. Patent Publication 2006/0103533 provides an inventory identification and control system that combines narrow band and ultra wideband transmission methods. Examples of narrowband technology may include LF, HF, UHF, IEEE 802.11a and 802.11b, BlueTooth, and microwave portions of the RF spectrum. Although the amount of output power can be regulated to ensure integrity of a neighboring spectrum against signal pollution, narrowband RFID technologies suffer from disadvantages such as low data rate, and susceptibility to interference. Ultra wideband (UWB) radio addresses these issues. UWB radio can communicate over a broad, i.e., ultra wide, spectrum (band), rather than fixed ranges that are common in typical narrow band radio. UWB radio has advantages of higher data rate, lower power consumption, location determination, and resistance to multipath distortion.

FIG. 1 is a diagram illustrating an example of a conventional combination narrowband/UWB system, as described in Patent Publication 2006/0103533. The system includes multiple readers in a local area network (LAN) network, each serving a number of tags. Each of the readers includes a narrowband transmitter and a UWB antenna, while each of the tags includes a UWB transmitter and a narrowband receiver. During downlink communication from the readers to the tags, each reader uses the narrowband transmitter to transmit narrowband channels to power and interrogate the tags. The narrowband signals can be continuous or sequentially pulsed. In response to receiving the narrowband signals, the tags use the UWB transmitter to transmit responses back to the readers as a stream of UWB impulses during an uplink communication. Each of the readers is connected to local servers and gateways through the LAN to make the inventory data from the tags available over the Internet.

Although this combination system is an improvement over RFID passive only systems that use a backscatter signal, the system has disadvantages. One disadvantage is that the system does not take advantage of the available long range of the UWB signals. For example, narrowband signals used to power the tag only have a free space range of around 13 meters (even though this range can be slightly extended by powering tags with electromagnetic energy from multiple frequencies). UWB signals, in contrast, can be read from hundreds of meters away. Consequently including narrow band and UWB technology in both the tags and the readers creates a downlink limited system. This means that a reader must be placed within 13 m of every tag, which requires the use of multiple readers to provide adequate coverage for many tags. And because there are multiple readers located in proximity to a subnet of tags, the system requires an infrastructure of local servers, gateways, and middleware to support Internet access and database functions, which can be very expensive.

An improved RFID architecture separates functions of wide band (the data channel) from the narrow band (the power channel) by moving the power channel from the reader to external power nodes. For example Tagent™ of Mountain View Calif., provides a UWB passive tag RFID system. The system includes tags having a passive RFID chip with a built-in antenna, a RFID interrogator/reader, and a network of power nodes that emit a 5.8 GHz RF signal for energizing the tags. The power nodes are deployed within 1 m of the tags and 2 m apart from one another and are used to determine a chip's location.

In operation, the reader transmits a 2.4 GHz wireless signal instructing a specific power node to emit RF energy to the tags at a frequency of 5.8 GHz as a narrowband pulse of power. The energy from that pulse is collected by the tag and stored in an internal or on-chip capacitor. Any tag within the power node's 1 m transmission range then transmits a tag ID via a 6.7 GHz signal, which is then received by the reader up to 10 m away. Because the tag responded to a specific power node, and because the system knows the location of the power node, the system can deduce that the tag is located within a maximum 1 m radius of the power node. By reducing the power pulse from its maximum, the size of the power-up radius can be reduced, thereby reducing location resolution to approximately 25 cm. The reader is connected to a backend server via built in Ethernet or Wi-Fi connections. Web-based software links the tag ID with the power node and its location, thereby identifying the tags location based on the information. This provides a real-time location system, since the reader can instruct the nodes to pulse very frequently, such as once a second, for example.

While a RFID architecture that separates tag power-up from tag read allows the system to have a greater flexibility than traditional RFID systems, the system also suffers from disadvantages. For example, because the architecture uses a RFID chip with a built-in antenna, and uses a 5.8 GHz power signal, the distance from which the chips can be powered is restricted. In addition, because the location of a tag is determined based on the known location of a power node, the location of a tag can only be determined within a set radius of the power node. In addition, tag location cannot be determined locally, but must be determined by web-based software, which requires support of a backend infrastructure such as servers and middleware, which increases the cost and complexity of the system.

A further example of a real-time location system (RTLS) is the STAR system by Mojix of Los Angeles Calif. The system includes one or more star receivers, multiple tag-excitation points, called enode transmitters, and a master controller connected to the Internet. Each receiver manages up to 512 enode transmitters, which may be arranged in a star network typology and oriented to define a three-dimensional coverage area. The enodes provide energy to UHF passive RFID tags within their specified interrogations areas. The receiver reads the resulting tag signals using a phased antenna array and uses digital processing techniques, such as beamforming and steering, to process the received signal and track the location of the signal source. This enables the system to determine where a RFID tag is located, and to track its path overtime. In contrast to the reader, the controller provides a point for data collection, communication with business processes, and command and control of the STAR system. The controller schedules resources, directs the STAR system to activate enodes, processes tag information, and serves as the integration point between a STAR system and enterprise applications. The controller also hosts applications and maintains statistics of successful reads in each interrogation space of the system.

Although Mojix's system may improve the read range and resolve location of the signal source using a UHF band, this system also includes disadvantages. One disadvantage is that a reader can manage only up to 512 enode transmitters, meaning that for large installations, an array of receivers may be required. Even installations were only one reader is required, the reader must still be connected to the controller to access Internet. Another disadvantage is that the readers utilize a phased antenna array, which is a group of antennas in which relative phases of the respective signals feeding the antennas are varied in such a way that the effective radiation pattern of the array is reinforced in a desired direction and suppressed in undesired directions. The use of advanced phased array technology and the need for multiple readers and a controller add the cost and complexity of the system.

Accordingly, a need exists for an improved real time tracking system that provides a long read range, while reducing cost and complexity.

### BRIEF SUMMARY

The exemplary embodiment provides methods and systems for providing a long-range real-time location system (RTLS) in which a plurality of tags are associated with respective items. Aspects of exemplary environments include transmitting a power signal from one or more exciters to at least a portion of the tags, wherein the exciters are located a distance from the tags within a range required to power the tags; initiating transmission of the power signal by a reader that transmits a command signal instructing the exciters to transmit the power signal to the tags, wherein the reader is located a greater distance from the tags than the range required to power the tags; receiving by multiple wideband antennas on the reader, wideband signals from at least one of the tags, and associating with the wideband signals a time of arrival at each of the wideband antennas; and calculating by the reader a location of the at least one tag based on differences between the time of arrival at each of the wideband antennas.

According to the method and system disclosed herein, the exemplary embodiment provide a long-range RTLS in which the tag reader includes multiple wideband antennas that enable calculation of tag location within the reader itself based on differences between time of arrival of UWB signals received from the tags. Power channel function is offloaded to the exciters, which enables the reader to perform long-range reading of the tags that is not range limited by a narrowband power downlink. Due to this long-range reading capability, the RTLS system only needs a single reader. The reader may further be configured as a network attached device that includes a web server that allows outside access to a tag database storing tag location information. Such a configuration reduces reliance on servers and middleware, further reducing system costs.

### BRIEF DESCRIPTION OF SEVERAL VIEWS OF THE DRAWINGS

FIG. 1 is a diagram illustrating an example of a conventional combination narrowband/UWB system.

FIG. 2 is a diagram illustrating one embodiment of a long-range passive real-time location system (RTLS).

FIG. 3 is a flow diagram illustrating a process for providing a long-range passive real-time location system.

FIG. 4 is a diagram illustrating primary components of an exciter according to one embodiment.

FIG. 5 is a block diagram illustrating main components of the reader in further detail according to one embodiment.

FIG. 6 is a block diagram illustrating a further aspect of the exemplary embodiment in which software as a service is used to process one or more long-range passive RTLSs.

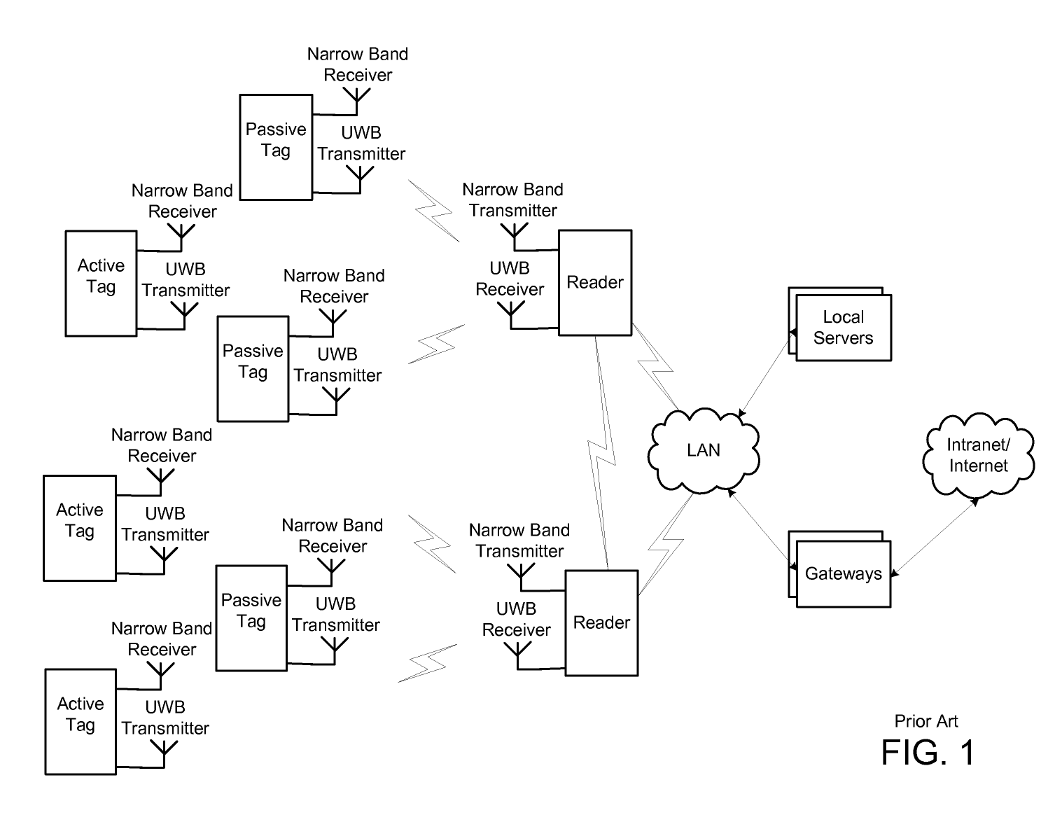

### DETAILED DESCRIPTION

The exemplary embodiment relates to providing a long-range passive real-time location system. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods for providing a long-range passive real-time location system. In one embodiment, a reader is provided that sends a command signal to exciters to energize a plurality of RFID tags via a short range narrowband power signal. In response, the tags transmit a tag ID to the reader via a long-range ultra wideband signal. The reader receives the ultra wideband signals using multiple ultra wideband antennas. The reader calculates a location of each of the tags based on a time-of-arrival of the ultra wideband signals at each of the ultra wideband antennas. The reader stores the tag ID and location information from each of the ultra wideband signals in an internal database. The reader further includes a web server for allowing outside access to the location information in the tag database over a network.

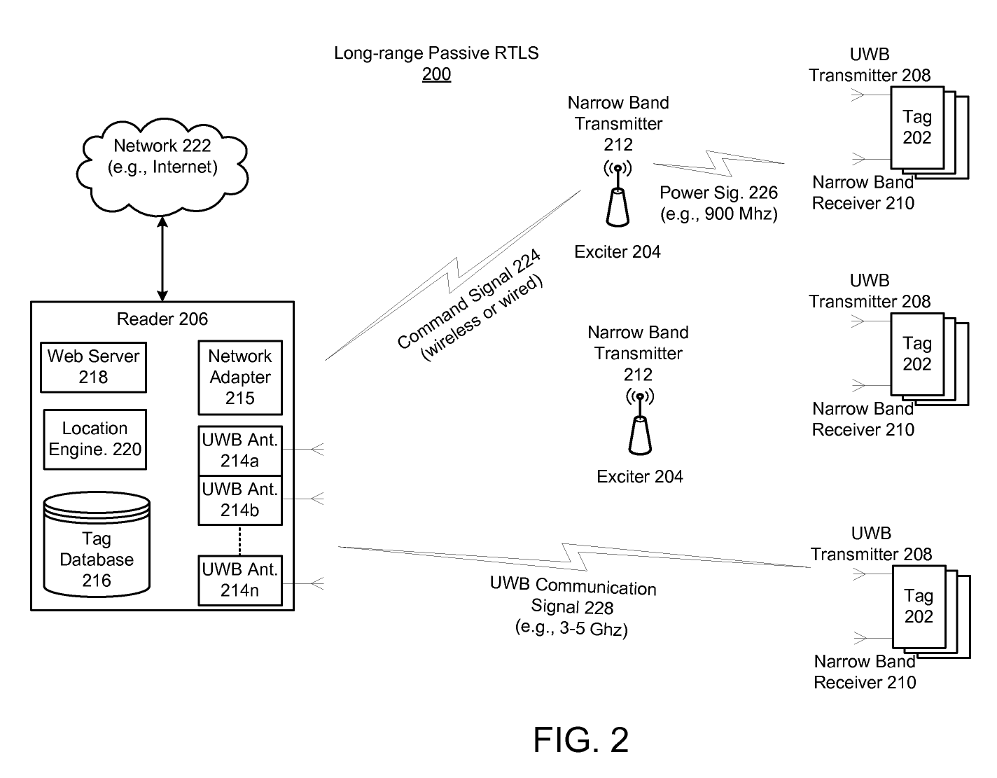

FIG. 2 is a diagram illustrating one embodiment of a long-range passive real-time location system (RTLS). The long range RTLS 200 includes a plurality of tags 202, a plurality of exciters 204, and a reader 206. Each of the tags 202 includes both an ultra wideband (UWB) transmitter 208 and a narrowband receiver 210. In one embodiment, the tags 202 comprise passive RFID tags that receive energy from an antenna, as opposed to active RFID tags that have their own power source. Each of the exciters 204, which are external to both the reader 206 and the tags 202, include a narrow band transmitter 212.

According to the exemplary embodiment, the reader 206 includes multiple UWB antennas 214a, 214b, 214n (collectively referred to as UWB antennas 214), a network adapter 215, a tag database 216, a location engine 220, and a web server 218. In a two dimensional (2-D) location system, the reader 206 may include a minimum of three UWB antennas 214 for location determination, and in a three-dimensional (3-D) system, the reader 206 may include a minimum of four UWB antennas 214.

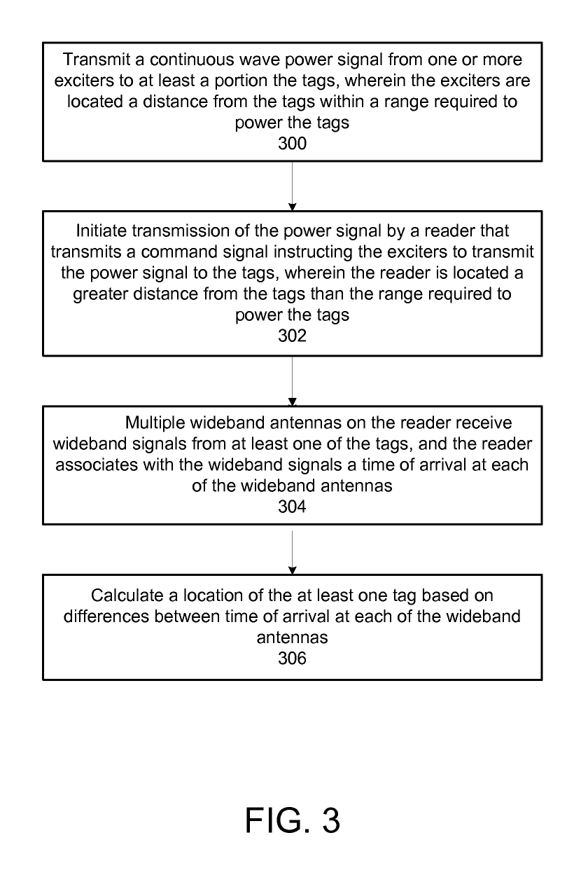

FIG. 3 is a flow diagram illustrating a process for providing a long-range passive real-time location system. Referring to both FIGS. 2 and 3, the process may include transmitting a power signal 226 from one or more exciters 204 to at least a portion the tags 202, wherein the exciters 204 are located a distance from the tags 202 within a range required to power the tags 202 (block 300). For example, the exciters 204 may be deployed within proximity to a subset of tags 202 (e.g., 10 m to 20 m) and emit a power signal 226 from the narrow band transmitter 212 as a continuous wave that energizes a subset of tags 202. In one embodiment, the power signal 226 may comprise a RF signal that is transmitted between 900 megahertz and 5.9 GHz.

In one embodiment, the tags 202 may include a passive RFID chip with a built-in narrowband receiver 210 that receives the power signal 226 (see for example, the tag configuration described in U.S. Patent Publication 2006/0103533, which is herein incorporated by reference). The tags 202 may store the energy from the power signal 226 in an internal or on-chip capacitor (not shown).

The transmission of the power signal is initiated by the reader 206 that transmits a command signal 224 instructing the exciters 204 to transmit the power signal 226 to the tags 202, wherein the reader 206 is located a greater distance from the tags 202 than the range required to power the tags 202 (block 302). In one embodiment, the reader 206 transmits the command signal 224 through the network adapter 215 via a wired or wireless connection. For example, the network adapter 215 may be configured to be compatible with various forms of network technologies, including but not limited to, Ethernet, powerline-based networking (e.g., Homeplug™), a wireless area network (WAN) such as Wi-Fi, WiMAX, and cellular, and a wireless personal area network (WPAN) such as Zigbee™

According to the exemplary embodiment, offloading the power channel function to the exciters 204 enables the reader 206 to perform long-range reading of the tags 202 that is not range limited by a narrowband power downlink. Thus, the reader 206 can be located significantly farther away from the tags 202 than the exciters 204. For example, in one embodiment, the reader 206 can be located 100 m from the tags 202, whereas the exciters are located 10-20 m from the tags 202. According to one embodiment, the long-range passive RTLS 200 system utilizes a single reader 206, although multiple readers 206 may be used in an alternative embodiment.

Multiple wideband antennas on the reader 206 receive wideband signals from at least one of the tags 202, and the reader 206 associates with the wideband signals a time of arrival at each of the wideband antennas (block 304). In one embodiment, the wideband antennas may comprise the UWB antennas 214, and the wideband signals from the tags 202 may comprise UWB communication signals 228. In one embodiment, the tags 202 transmit the UWB communication signals 228 in response to receiving the power signal 226 from the exciters 204. In one embodiment, the UWB communication signals 228 may be transmitted at between 3-5 GHz. Communication between the tags 202 and the reader 206 and the decoding thereof may be performed according to a communication protocol described in U.S. Patent Publication 2009/0051496, which is herein incorporated by reference.

Each of the UWB communication signals 228 may include a tag identification (ID) that identifies the transmitting tag. In response to receiving the UWB communication signals 228 from the tags 202, the reader 206 may extract the tag ID and associate the time of arrival of the UWB communication signal 228 at the each of the UWB antennas 214 with the extracted tag ID.

The reader 206 then calculates a location of the tag based on differences between the time of arrival of the tag's wideband signal at each of the wideband antennas to (block 306).

According to the single reader 206 architecture described in FIGS. 2 and 3, infrastructure complexities of the long-range passive RTLS 200 are reduced since the reader 206 is further configured as a network attached device that includes the tag database 216, the web server 218 software and the location engine 220. According to one aspect, because the reader 206 includes multiple UWB antennas 214, the location engine 220 can determine the location of a particular tag 202 based on time of arrival of the tag's UWB communication signal 228 at each of the UWB antennas 214. Any tag ID received from a tag and the tag's calculated location may be stored in the tag database 216. The reader 206 can instruct the exciters 204 to transmit the power signal 226 frequently, such as once a second, for example, providing a real-time location system. The web server 218 inside the reader 206 enables location data from the tag database 216 to be made available over a network 222, such as a LAN, Internet, intranet, and the like.

Thus, instead of having multiple readers 206 connected to a server through middleware or a controller, the reader 206 becomes a networked enabled embedded device that stores tag information in the tag database 216 and allows outside communication via the built-in web server 218. Such a configuration reduces reliance on middleware, servers and multiple other readers 206, reducing system costs. Furthermore, the multiple UWB antenna architecture allows the RTLS system 200 to take advantage of wideband signal properties that enables tag location determination.

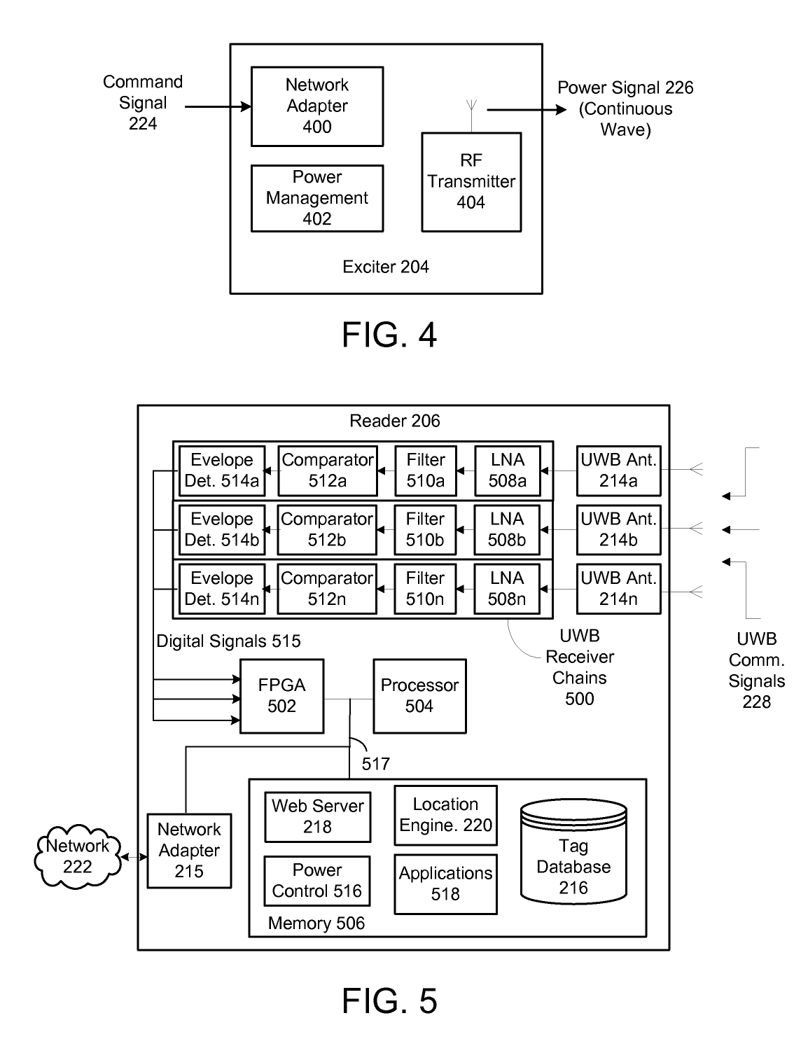

FIG. 4 is a diagram illustrating primary components of an exciter according to one embodiment. The exciter 204 includes a network adapter 400, power management 402, and an RF transmitter 404. The network adapter 400 enables the exciter 204 to receive communication, such as the command signal 224, from the reader via a wired or wireless connection. The network adapter 400 may be configured to be compatible with various forms of network technologies, including but not limited to, Ethernet, powerline-based networking (e.g., Homeplug™), a wireless area network (WAN) such as Wi-Fi, WiMAX, and cellular, and a wireless personal area network (WPAN) such as Zigbee™

The power management 402 includes power circuitry for powering the exciter 204. External power may be received from a 120 V or 240 V plug, or power over Ethernet. In one embodiment where power over Ethernet is used, Ethernet may be used for both power and for receiving communication signals. The RF transmitter 404 includes RF circuitry for producing the power signal 226 as a continuous wave (sine wave), which is used to energize the tags 202. In one embodiment, the exciter 204 is continually powered. And in response to the exciter 204 receiving the command signal 224 through the network adapter 400, the RF transmitter 404 sends out the continuous wave power signal 226 to energize the tags 202 within the exciter's range.

In one embodiment, the power signal 226 may be made directional or omnidirectional by configuration of the RF transmitter's antenna. In this embodiment, communication from the reader 206 to the exciter 204 may be configured for flexibility, such that the reader 206 can attenuate the power of the RF transmitter 404 be a directional antenna to cover tag areas differently for custom installations. In a further embodiment, a small processor may be added to the exciter 204 that is programmed with different states that are mapped to different antenna configurations.

FIG. 5 is a block diagram illustrating main components of the reader 206 in further detail according to one embodiment, where like components from FIG. 2 have liked reference numerals. In addition to the components shown in FIG. 2, the reader 206 may include a UWB receiver chain 500, a field programmable gate array (FPGA) 502, a processor 504, and a memory 506.

The processor 504 executes software stored in the memory 506, which in addition to the web server 218 and the location engine 220, may include power control 516, and other desired applications 518. One example of a type of processor that may be used is an ARM11 processor by ARM, Inc.

The power control 516 executes logic within the reader 206 that controls timing and a pattern of activation of the exciters 204, which controls activation of the tags 202. The power control 516 instructs the reader 206 to send a command signal 224 to particular exciters 204. In response, the exciters 204 transmit the power signal 226 to energize tags 202 within range. In one embodiment, the power signal 226 may include control information, as described in U.S. Patent Publication 2009/0051496. The timing and pattern that the tags are energized is determined by configuration.

For example, assume a RTLS includes 100 exciters 204 and 10,000 tags within 10 m of each of the exciters 204. In this environment, not all the exciters 204 can be activated at once because the reader 206 would receive UWB communication signals 228 from one million tags at once and become saturated. This is avoided by the power control 516 logic being configured to set a desired pattern of activation. As another configuration example, assume the case where the reader 206 receives an ID for the first time. It may be uncertain whether this is actually the first time the tag 202 has been read, or whether an exciter 204 failed to energize the tag due to interference, for instance. Therefore, the power control 516 can be configured to verify first readings of a tag ID by instructing the exciters 204 to energize the area of the transmitting tag 202 repeatedly. By repeating the energizing and reading process, it can be determined whether previous readings missed the tag 202 or whether the first time tag reading was in error. In one embodiment, the power control logic 516 can be customized by end-user.

The UWB communication signals 228 from transmitting tags 202 are received by the multiple UWB antennas 214 and input to respective UWB receiver chains 500. In an alternative embodiment, the reader 206 may include a different a different number of UWB receiver chain 500 than shown.

Each of the UWB receiver chains 500 receives the UWB communication signals 228 as a series of impulses, processes the impulses into a timeframe and outputs respective digital signals 515. Each of the UWB receiver chains 500 may comprise analog circuitry that includes low noise amplifiers (LNA) 508a 508b, 508n, filters 510a, 510b, 510n, a comparator 512a, 512b, 512n, and an envelope detector 514a, 514b, 514n.

The LNAs 508a 508b, 508n are amplifiers that amplify weak signals captured by an UWB antennas 214a, 214b, 214n. The filters 510a, 510b, 510n are circuits that pass frequencies within a predetermined range and reject (attenuates) frequencies outside that range. In one embodiment, the filters 510a, 510b, 510n may comprise a band pass filter and a low pass filter, and there may be multiple LNA and band pass stages. The comparators 512a, 512b, 512n may compare two voltages or currents from the filters 510a, 510b, 510n and switch an output to indicate which is larger. The envelope detectors 514a, 514b, 514n are circuits that receive high-frequency output signals from the comparator 512a, 512b, 512n and provide an output that is an envelope of the original signal.

The UWB communication signals 228 comprise a series of RF impulses without a continuous carrier, but each impulse may oscillate in duration. Even though impulses from various tags 202 are received, the analog circuitry of the UWB receiver chains 500 are capable of outputting the digital signal 515 without the need for an analog-to-digital-converter. In one embodiment, an analog-to-digital converter may be used to obtain improved location precision, but this may increase costs.

The digital signal 515 is input to the FPGA 502, which is hardware that runs microcode for decoding the digital signal 515. In one embodiment, the FPGA 502 may be configured to decode the digital signal 515 using a protocol as described in U.S. Patent Publication 2009/0051496. The FPGA 502 determines which UWB communication signal 228 was transmitted by which tag 202 at which times by extracting the tag ID from each of the UWB communication signals 228 and associating a time of arrival (or receive time) of each of the UWB communication signals 228 with the extracted tag ID, thus forming a series of tag ID and time-of-arrival pairs. The UWB communication signal 228 corresponding to a particular tag ID will be received by each of the multiple UWB antennas 214. Therefore, the FPGA 502 outputs multiple tag ID and time-of-arrival pairs for each transmitting tag 202. The output of the FPGA 502 is a signal 517 comprising stream of tag ID and time-of-arrival pairs corresponding to the UWB communication signals 228 received by the multiple UWB antennas 214.

According to one embodiment, the location engine 220 executing within the reader 206 uses the series of tag ID and time-of-arrival pairs to determine a location of each transmitting tag 202 based on a time difference of arrival (TDOA) algorithm. For each extracted tag ID, the TDOA algorithm may use a known speed of propagation of the of the UWB communication signals 228, a distance between the UWB antennas 214, and differences between the times of arrival at each of the UWB antennas 214 to calculate a distance of a corresponding tag 202. The time of arrival from three of the UWB antennas 214 narrows a location to a curve in space and the time of arrival from a fourth UWB antenna 214 can be used to pinpoint a specific location of the tag 202. In one embodiment, the location is may be represented as x, y coordinates in a 2-D system, while the location may be represented by x, y, z coordinates in 3-D systems.

Once the location of each transmitting tag 202 is determined, the tag ID, the location of the tag, and optionally the time-of-arrival may be stored in the tag database 216. In one embodiment, the tag ID may be represented by 96 bytes and location may be represented by 120 bytes, totaling 216 bytes for each reading. In an example RTLS that includes 10,000 tags 202 that are capable of being read simultaneously by the reader 206 each second, the storage required to store the tag ID and location for a day of tag readings may be approximately 5 GB.

To reduce storage requirements, memory optimization may be performed on the tag database 216 according to one embodiment. Rather than automatically storing in the tag database 216 every new entry of tag ID, location and time-of-arrival, the memory optimization may perform a query on the tag database 216 to determine if the corresponding tag is stationary or moving. For example, the memory optimization may query the tag database 216 with the tag ID from the new entry and compare the location in the most recent entry for that tag ID with the location from the new entry. If the two locations are less than a threshold distance apart, then it can be determined that the tag has not moved and the new entry will not be stored to conserve space. Instead, the time-of-arrival in the most recent entry may be updated with the time-of-arrival from the new entry.

In one embodiment, the web server 218 and network adapter 215 may allow outside access to the tag database 216 over the network 222 (e.g., Internet or intranet). The example uses of the tag database 216 may include online backups, applications 518 executing within the reader 206 that analyze the location data, or if the processor 504 lacks sufficient processing capabilities, for example, software may be used that is available over the network 222 and run on a server. Because the reader 206 functions as a network attached device, the RTLS system 200 does not require additional servers or middleware for data accessibility.

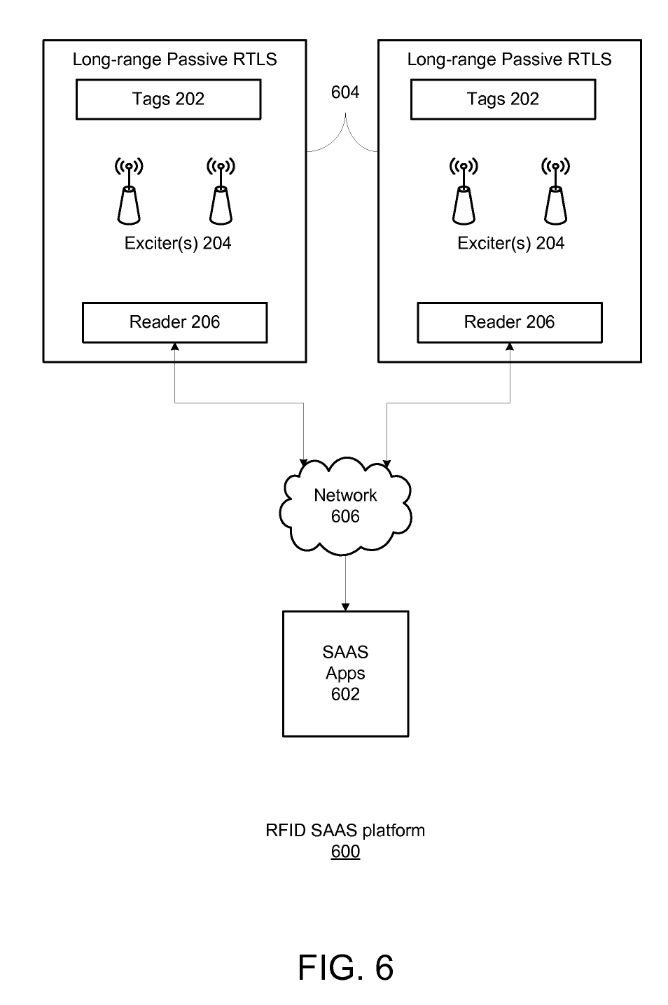

FIG. 6 is a block diagram illustrating a further aspect of the exemplary embodiment in which software as a service is used to process one or more long-range passive RTLSs. According to one aspect, an RFID software as a service (SAAS) platform 600 may be provided whereby a provider licenses one or more SAAS applications 602 for use as an on demand service executing over a network 606 (i.e., in a cloud) to entities owning or controlling a long-range passive RTLS 604 for analysis of the tag database 216.

One example of a SAAS application 602 running in the cloud is an application that does inventory balancing across multiple stores wherein the tags 202 are affixed to items in the stores. The SAAS application 602 be run on a server in a data center and may include a web interface that pulls data from the tag databases 216 of multiple readers 206. Once the location data is pulled from the tag databases 216, load-balancing may be performed by shifting inventory from one store to another in an effort to make supply meet demand.

Another example of a SAAS application 602 may be a retail application that performs path optimization and/or price optimization. One function of this application could be to inform customers of the location of every item in the store(s) to reduce or eliminate phantom stock items, overstock items and under stocked items. This may be performed by querying the tag database 216 to determine in real-time the number and location of each item in the store. Inventory balancing may be performed to make supply meet demand by comparing inventory items with the location data in the tag database 216 and monitoring when items leave the store. When an inventory of a particular item falls below a particular threshold, the application may automatically initiate a reorder or shift inventory from another store, particularly if that store has an overstock of that item.

In another embodiment, a SAAS application 602 could determine most/least popular items in a retail clothing store by tracking the items that were moved off the rack into a fitting room and tried on by customers the most often, for example. Underperforming items may be moved from a back corner closer to the point of sale (POS) system so that the items may be viewed by more customers.

Because the readers 206 of the exemplary embodiment supply real-time location information, more precise inventory management may be performed. For example, improved methods for performing price optimization may be provided that make supply meet demand for items at list prices based on location analysis, rather than lowering prices to make the supply of items meet demand based on estimated statistics.

A method and system for providing a long-range passive real-time location system has been disclosed. In one embodiment, the location engine 220, the power control 516, and other applications 518 are implemented as software components. In another embodiment, the components could be implemented as a combination of hardware and software. Although the location engine 220, the power control 516, and other applications 518 are shown as separate components, the functionality of each may be combined into a lesser or greater number of modules/components. In addition, although a processor 504 is shown executing the location engine 220, the power control 516, and other applications 518, the location engine 220, the power control 516, and other applications 518 may be run on any number or type processors.

The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

We claim:

1. A computer-implemented method for providing a long-range real-time location system in which a plurality of tags are associated with respective items, comprising:
transmitting a power signal from one or more exciters to at least a portion the tags, wherein the exciters are located a distance from the tags within a range required to power the tags;
initiating transmission of the power signal by a reader that transmits a command signal instructing the exciters to transmit the power signal to the tags, wherein the reader is located a greater distance from the tags than the range required to power the tags;
receiving by multiple wideband antennas on the reader, wideband signals from at least one of the tags, and associating with the wideband signals a time of arrival at each of the wideband antennas; and
calculating by the reader a location of the at least one tag based on differences between the time of arrival at each of the wideband antennas.

2. The method of claim 1 wherein the reader comprises a single reader.

3. The method of claim 1 wherein the wideband signals comprise ultra wideband (UWB) signals and the wideband antennas comprises UWB antennas.

4. The method of claim 3 further comprising extracting a tag ID from the UWB signals, and associating the time of arrival of the UWB signals at the each of the UWB antennas with the tag ID.

5. The method of claim 4 further comprising inputting the UWB signals as a series of impulses into a UWB receiver chain that processes the impulses into a timeframe and outputs a digital signal.

6. The method of claim 5 further comprising inputting the digital signal into a field programmable gate array (FPGA) that extracts the tag ID from each of the UWB signals and associates the time of arrival of each of the UWB signals with the tag ID, forming a series of tag ID and time-of-arrival pairs.

7. The method of claim 6 wherein calculating the location of at least one tag further comprises executing a location engine within the reader is that uses the tag ID and time-of-arrival pairs and a distance between the UWB antennas to determine a location of each transmitting tag based on a time distance of arrival algorithm.

8. The method of claim 7 further comprising storing at least the tag ID and the location in a tag database within the reader.

9. The method of claim 8 further comprising performing memory optimization on the tag database to reduce memory requirements.

10. The method of claim 8 further comprising executing a web server within the reader to allow outside access to the tag database over a network.

11. The method of claim 1 further comprising providing an RFID software as a service (SAAS) platform whereby a provider licenses one or more SAAS applications for use as an on demand service executing over a network to entities controlling the long-range passive RTLS for analysis of the tag database.

12. The method of claim 1 wherein the exciters include an RF transmitter that is configurable to make the power signal directional or omnidirectional.

13. The method of claim 12 further comprising executing logic within the reader the controls timing and a pattern of activation of the exciters.

14. A system, comprising:
one or more exciters that transmit a power signal to at least a portion of a plurality of tags, wherein the exciters are located a distance from the tags within a range required to power the tags; and
a reader that initiates transmission of the power signal by transmitting a command signal to the exciters, wherein the reader is located a greater distance from the tags than the range required to power the tags, wherein the reader is configured to:
receive by the multiple wideband antennas, wideband signals from at least one of the tags, and associate with the wideband signals a time of arrival at each of the wideband antennas; and
calculate a location of the at least one tag based on differences between the time of arrival at each of the wideband antennas.

15. The system of claim 14 wherein the reader comprises a single reader.

16. The system of claim 14 wherein the wideband signals comprise ultra wideband (UWB) signals and the wideband antennas comprises UWB antennas.

17. The system of claim 16 wherein the reader extracts a tag ID from the UWB signals, and associates the time of arrival of the UWB signals at the each of the UWB antennas with the tag ID.

18. The system of claim 17 wherein the UWB signals are input as a series of impulses into a UWB receiver chain that processes the impulses into a timeframe and outputs a digital signal.

19. The system of claim 18 wherein the digital signal is input into a field programmable gate array (FPGA) that extracts the tag ID from each of the UWB signals and associates the time of arrival of each of the UWB signals with the tag ID, forming a series of tag ID and time-of-arrival pairs.

20. The system of claim 19 wherein the reader executes a location engine that uses the tag ID and time-of-arrival pairs and a distance between the UWB antennas to determine a location of each transmitting tag based on a time distance of arrival algorithm.

21. The system of claim 20 wherein the reader stores at least the tag ID and the location in a tag database within the reader.

22. The system of claim 21 wherein the reader performs memory optimization on the tag database to reduce memory requirements.

23. The system of claim 21 wherein the reader executes a web server within the reader to allow outside access to the tag database over a network.

24. The system of claim 14 further including a RFID software as a service (SAAS) platform whereby a provider licenses one or more SAAS applications for use as an on demand service executing over a network to entities controlling the long-range passive RTLS for analysis of the tag database.

25. The system of claim 14 wherein the exciters include an RF transmitter that is configurable to make the power signal directional or omnidirectional.

26. The system of claim 25 wherein the reader executes logic that controls timing and a pattern of activation of the exciters.

27. An executable software product stored on a computer-readable medium containing program instructions for providing a long-range real-time location system in which a plurality of tags are associated with respective items, the program instructions for:
transmitting a power signal from one or more exciters to at least a portion the tags, wherein the exciters are located a distance from the tags within a range required to power the tags;
initiating transmission of the power signal by a reader that transmits a command signal instructing the exciters to transmit the power signal to the tags, wherein the reader is located a greater distance from the tags than the range required to power the tags;
receiving by multiple wideband antennas on the reader, wideband signals from at least one of the tags, and associating with the wideband signals a time of arrival at each of the wideband antennas; and
calculating by the reader a location of the at least one tag based on differences between the time of arrival at each of the wideband antennas.

28. A tag reader, comprising:
a plurality of ultra wideband antennas that receive ultra wideband signals from tags, the ultra wideband (UWB) signals including a tag ID of a corresponding transmitting tag;
a plurality of UWB receiver chains that receive the UWB signals as a series of impulses and processes the impulses into a timeframe and outputs a digital signal;
a field programmable gate array (FPGA) that receives the digital signal from each of the plurality of UWB receiver chains, extracts the tag ID from each of the UWB signals, and associates the time of arrival of each of the UWB signals with the tag ID, forming a series of tag ID and time-of-arrival pairs;
a memory that stores a location engine, tag database, and web server; and
a processor that executes the location engine wherein the location engine uses the tag ID and time of arrival pairs and a distance between the UWB antennas to determine a location of each transmitting tag based on a time distance of arrival algorithm, wherein at least the tag ID and the location are stored in a tag database, and wherein the processor further executes the web server to allow outside access to the tag database over a network.

29. A method for providing a long-range passive real-time location system, comprising:
sending a command signal from a reader to one or more exciters to energize a plurality of RFID tags via a short range narrowband power signal;
in response to the tags receiving the power signal, transmitting a tag ID to the reader via a long-range ultra wideband signal;
receiving the ultra wideband signals using multiple ultra wideband antennas on the reader;
calculating by the reader a location of each of the tags based on a time-of-arrival of the ultra wideband signals at each of the ultra wideband antennas;
storing the tag ID and location information from each of the ultra wideband signals in a database on the reader; and
allowing outside access to the location information in the database over a network.
